(19) United States
(12) Patent Application Publication
(10) Pub. No.: US 2017/0024828 A1
(43) Pub. Date: Jan. 26, 2017

(54) SYSTEMS AND METHODS FOR IDENTIFYING INFORMATION RELATED TO PAYMENT CARD TESTING

(71) Applicant: PALANTIR TECHNOLOGIES INC., Palo Alto, CA (US)

(72) Inventors: Jean-Baptiste MICHEL, Brooklyn, NY (US); Barry MCCARDEL, New York City, NY (US); Daniel NORRIS, New York City, NY (US); Craig SAPERSTEIN, New York City, NY (US); Christopher GLEN, Los Angeles, CA (US); Eric DENOVITZER, New York City, NY (US)

(21) Appl. No.: 14/923,374

(22) Filed: Oct. 26, 2015

Related U.S. Application Data
(60) Provisional application No. 62/196,195, filed on Jul. 23, 2015.

(51) Int. Cl. G06Q 40/00

(52) U.S. Cl. CPC G06Q 40/12

(57) ABSTRACT

Approaches for determining a potential payment card that has been tested or a testing site are disclosed. Based on a variety of information, including transaction information associated with one or more cards, information indicative of unscrupulous actors vetting cards can be determined. By reviewing transaction information, patterns can emerge such as a card being used in many different locations within a short time span. Based on these patterns, a test site or compromised merchant can be determined. After a test site is determined, other cards used at the particular test site can also be determined.

### CROSS REFERENCE TO RELATED APPLICATIONS

This application claims priority to U.S. Provisional Patent Application No. 62/196,195, which was filed on Jul. 23, 2015, and the disclosures of which are expressly incorporated herein by reference in their entirety.

### BACKGROUND

The amount of data being processed and stored is rapidly increasing as technological advances allow users to generate and store increasing amounts of data. Today, large sets of data can be stored in various data structures such as databases. For example, information associated with finger prints and facial recognition systems are stored in large datasets. Similarly, information associated with hospital records, financial records, and legal documents are also stored in large data structures. Moreover, information associated with merchant transactions such as payment card information can be stored.

As data storage became more affordable, large and complex datasets became more ubiquitous. Advances in computing technology similarly helped fuel the growth of what is commonly referred to as Big Data. In addition to the rise of Big Data, during the same period payment card transactions surpassed over 50% of non-cash transactions, as personal checks grew out of favor. Part of this was due to the rising popularity of debit cards which, as opposed to credit cards, allowed money to be transferred directly from a user's account rather than requiring a user to pay a credit card company the money at a later date.

Data breaches involving payment card information has also increased in recent decades. Large data structures used to store payment card information became increasingly popular as merchants were able to monitor user behavior based on payment card information and transaction information involving those payment cards. The sheer amount of information included in these data structures, combined with outdated technology, in some cases, has fueled an increase in payment card breaches. These breaches, whether caused by a hacked card reader, or a hacked data structure, can potentially put information associated with thousands of payment cards into the hands of unauthorized users.

Breaches perpetrated by bad actors such as hackers are increasingly sophisticated. When gaining access to information, these hackers use a variety of techniques to disguise their activities. For instance, a hacker may gain access to a card reader or data structure, and wait for a period of time before using stolen card data. As such, companies that are attacked may not know about the attack for weeks or even months. Further, when an issuing bank or card association discovers a breach, the bank or association may not be able to easily trace the source of a breach. They may notice that many cards are being reported as compromised, but not have a way to determine the date or location of where the card information was stolen. This, in turn, exposes a company, bank, or association to further financial liability because there may be additional compromised cards that have yet to be identified.

Thus, there is a need in the art for a better way to determine the date and location of potential breaches. By determining when and where a breach occurred, a company, an issuing bank, or a card association may be able to identify potentially compromised cards and notify the cards' holders or deactivate the cards. This determination, however, can be difficult because the amount of data required is very large. Previously, many cards would need to be reported as compromised before a company, bank, or association could begin to piece together circumstantial evidence of a potential breach by cross-referencing transaction data. This process was time consuming and often did not reliably indicate when or where a breach had occurred. As such, because data associated with millions of card transactions does not avail itself to trend determination with ease, new systems are currently being developed to identify breaches in very little time.

One common component in credit card breaches is the post-breach testing of cards in order for the perpetrators to determine whether charges will be accepted by the stolen cards. Identifying instances of such testing can facilitate the identification of not only the stolen cards, but also whether an when a breach has occurred. Generally, testing card information refers to determining whether or not a certain card behaves in a particular way (e.g., whether a card is accepted or declined when used). Testing is generally not used to purchase anything, but instead only to determine how a card behaves or responds to the testing conditions. Names of testing sites can appear to be regular stores on a credit card statement (e.g., a real department store or a hotel), but testing sites typically use phony names and the testing of cards typically doesn't have anything to do with an actual purchase. It is contemplated that a perpetrator can run a list of credit cards through a computer, which disguises test transactions by inserting phony names into the merchant field of the transaction. Identifying these tests and test sites can assist with the identification of card breaches (e.g., determining when and where card information was compromised).

### BRIEF DESCRIPTION OF THE DRAWINGS

Reference will now be made to the accompanying drawings, which illustrate exemplary embodiments of the present disclosure and in which:

FIG. 1 is a block diagram of an exemplary computer system, consistent with embodiments of the present disclosure;

FIG. 2 is a diagram that illustrates an exemplary system used for payment card transactions, consistent with embodiments of the present disclosure;

FIG. 3 is a diagram that illustrates an exemplary network environment used for payment card transactions, consistent with embodiments of the present disclosure;

FIGS. 4-7 are illustrations of exemplary interfaces for identifying potential information related to payment card breaches, consistent with embodiments of the present disclosure;

FIG. 8 is a flowchart representing an exemplary method for identifying potential merchant breaches, consistent with embodiments of the present disclosure;

FIG. 9 is an illustration of an exemplary user interface for identifying potential tested cards and/or test sites, consistent with embodiments of the present disclosure; and

FIG. 10 is a flowchart representing an exemplary method for identifying potentially tested payment cards and/or test sited, consistent with embodiments of the embodiments of the present disclosure.

### DETAILED DESCRIPTION OF EXEMPLARY EMBODIMENTS

Reference will now be made in detail to exemplary embodiments, the examples of which are illustrated in the accompanying drawings. Whenever possible, the same reference numbers will be used throughout the drawings to refer to the same or like parts. Herein, the terms cards, payment cards, credit cards, debit cards, and the like may be used interchangeably. Similarly, the terms card health, card health scores, card health values, health values, and the like can be used interchangeably, and generally refer to a score indicating the likelihood that a card was compromised. Lastly, the specification below is divided into various sections for the ease of reading alone. These sections include: (1) card breach detection; and (2) a description of card testing detection.

### Card Breach Detection

Some embodiments of the invention described herein generally relate to determining whether a merchant's payment system has experienced a security breach, to determine the likelihood of whether information included in a merchant's system (e.g., information associated with consumers' payment cards or accounts) has been obtained by an unauthorized user. Some embodiments described herein discuss determining whether an information storage system (e.g., a merchant's payment system) has experienced a security breach, to determine whether information included the system (e.g., information associated with consumers' payment cards or accounts) may have been obtained by an unauthorized user. In various embodiments, patterns (which can be displayed as graphs) can be used to determine whether a merchant was breached.

Often, system breaches are not apparent until a banking institution determines from a consumer that a breach has occurred. Banks or other institutions may review fraudulent activities across multiple consumer payment card accounts and multiple transactions that may reveal a common point of payment card usage, which may correspond with the entity whose system was the target of a security breach. Such analysis can take significant amounts of time and involve a rearward-looking focus to identify breaches—often well after they have occurred.

The systems described herein involve a forward-looking monitoring solution that can potentially identify breaches earlier than current techniques. The system may involve determining payment card transaction data and monitoring common points of usage as well as monitoring ongoing payment card health.

In embodiments described herein, breaches may be detected earlier than in traditional manners. For instance, whereas a card issuer or other entity typically discovers a breach when a particular number of cards are cancelled by users that realized their cards have been breached, systems and methods described herein consider and process a variety of information (e.g., whether a card has been declined), at least in part, to determine whether cards have been breached. In the past, typically a consumer called a bank to cancel the card, and the bank used an investigator to determine where the breach occurred. While embodiments described herein may implement such techniques, various embodiments described herein may maintain a database (or other type of data storage) that processes and/or stores which cards were used where and when. Later, if one or more cards are marked (also referred to herein as flagged) with a signal of interest, such as a card being declined, the database may be searched for other cards that may have a similar signal of interest, were used at a common place of purchase, and/or at a particular time period.

Systems and methods described herein may determine a potential breach much sooner than if a card issuer waited for a consumer to notify it of an issue with a card (or to provide another indicator of a potential breach). Because embodiments described herein may focus more on a high volume of low probability indicators of breaches (e.g., declines) as opposed to a low volume of high probability indicators (e.g., customers calling to cancel their cards), false positives and negatives are easier to identify, especially when viewed on a graph. Moreover, embodiments described herein are able to calculate a time of a breach with greater precision. As an example, when a few callers that notify a card issuer of a problem, the card issuer may not be able to pinpoint the time or extent of the breach easily. Due to the high volume of transactions analyzed in embodiments described herein, the time and extent of a potential breach may be determined sooner and with greater accuracy. In addition, because some embodiments described herein are able to recognize a breach prior to any consumer calling to report fraudulent activity (e.g., if the embodiments described herein identify a strange pattern in card usage), breaches may be discovered much sooner than if companies, card issuers, or card associations were to wait for consumers to notify them of a potential breach.

To provide these advantages, the presently disclosed system may make use of any sources of information suitable for enabling a determination of one or more security breaches. For example, sources of information can include, but are not limited to: financial institutions, card associations, merchants, card testing sites, web and/or underground markets for stolen card information, etc. In some embodiments, data associated with transactions occurring at particular merchants may be used to determine security breaches. Some merchants may be associated with particular health scores (also referred to as merchant health scores or merchant breach scores). This association may be determined by a financial institution such as a bank, a card association, an insurance company, etc. either automatically or by an analyst. Alternatively, or in addition, in some embodiments card health (e.g., a score indicating the likelihood of a compromised card) associated with payment cards used at various merchants may be used to determine security breaches. Similarly, card health scores can be assigned and/or determined by a financial institution, card association, insurance company, etc. The various sources of information (merchants, banks, associations, etc.) may be compared, and a determination can be made on an ongoing basis as to the likelihood that a breach has occurred at a particular merchant. This determination may be based on a comparison of transactions on a particular date at the particular merchant and a forward-looking aggregation of payment card health scores. The determinations of card health scores, merchant health scores, and/or potentially breached merchants can be provided to a variety of users, including a government agency such as law enforcement, insurance companies, merchants, financial institutions, card associations, etc.

In some of the embodiments, a base line is used to normalize breach scores. That is to say, in order to remove false positives, cards with breach scores associated with them may be compared to a baseline (e.g., average card behavior, comparable merchants such as nearby merchants, etc.). Further, data associated with where a transaction occurred can come from various data sources. For example, insurance data may be scraped to determine where a potential breach occurred. In addition or alternatively, each merchant can be viewed in real time.

Various graphs may be representative of the types of analysis performed by the disclosed systems. As will be described below, graphs comparing the analyzed data may be provided to a user interface to enable an analyst to assess the likelihood of a breach. Alternatively, or additionally, the likelihood of a breach along with other identifying information associated with the breach may be calculated, and the calculated information could be provided as output to a user interface or to one or more automated tracking systems.

These graphs may be represented as triangle graphs, as shown in the figures. The X-axis may represent transaction date for payment card transactions at a certain entity (e.g., Store X). The vertical axis plots payment card health (e.g., a card status score) as of the particular date on the Y-axis. The amount of card health data available accumulates over time such that more health information is available as time progresses.

Moreover, in various embodiments, approaches described herein can detect breaches associated with personal identifying information (PII). For example, a first set of data including transactions made using PII (e.g., a request for a credit report) and a second set of data including compromised PII (e.g., a set of social security numbers associated with people with compromised PII) can be compared to determine entities that are associated to higher rates of compromised PII. In such an example, which can be determined using the approaches described herein associated with payment cards, an employer may be found to have a larger proportion of employees with compromised PII than other employees.

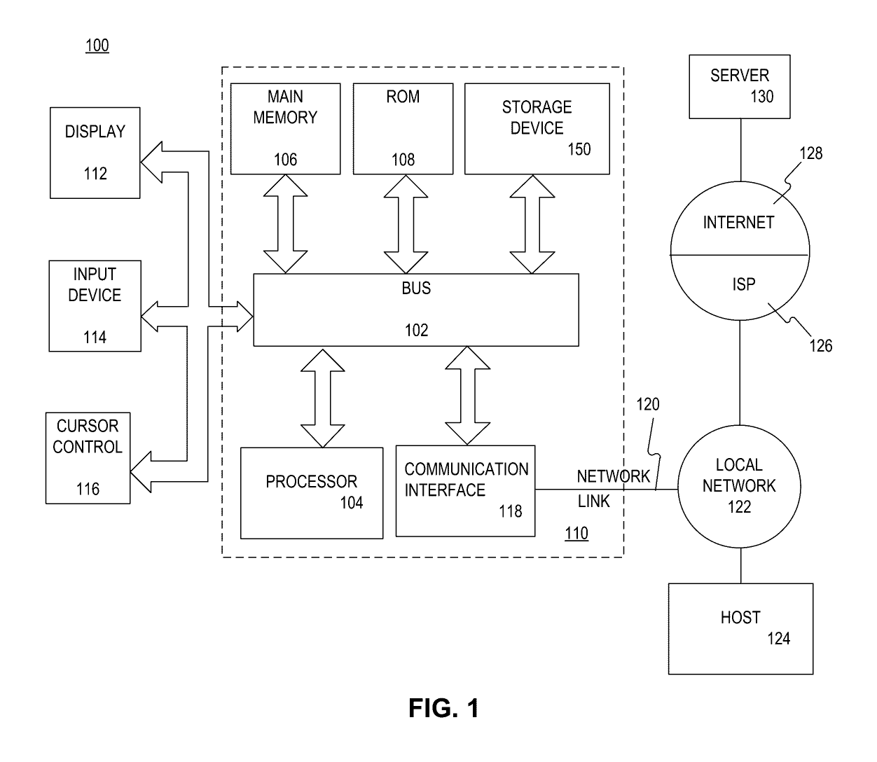

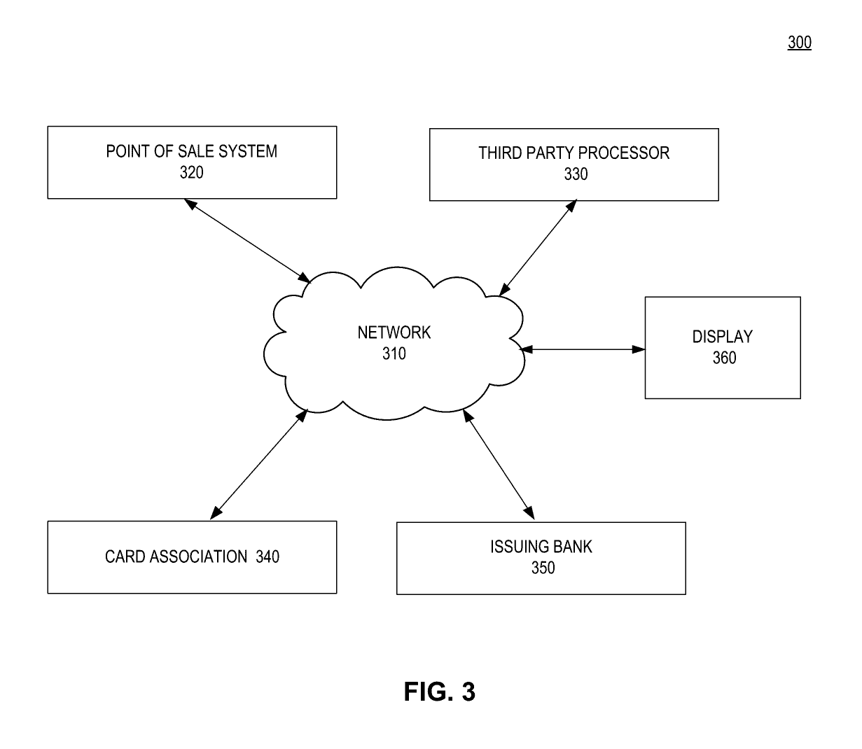

FIG. 1 is a block diagram of an exemplary computer system 100, consistent with embodiments of the present disclosure. The components of various components described herein, such as environment 300 (of FIG. 3) that includes point of sale (PoS) system 320, third party processor 330, card association 340, issuing bank 350, and/or display 360 may include the architecture based on or similar to that of computer system 100.

As illustrated in FIG. 1, computer system 100 includes a bus 102 or other communication mechanism for communicating information, and one or more hardware processors 104 (denoted as processor 104 for purposes of simplicity) coupled with bus 102 for processing information. Hardware processor 104 can be, for example, one or more microprocessors or it can include a reduced instruction set of one or more microprocessors.

Computer system 100 also includes a main memory 106, such as a random access memory (RAM) or other dynamic storage device, coupled to bus 102 for storing information and instructions to be executed by processor 104. Main memory 106 also can be used for storing temporary variables or other intermediate information during execution of instructions to be executed by processor 104. Such instructions, after being stored in non-transitory storage media accessible to processor 104, render computer system 100 into a special-purpose machine that is customized to perform the operations specified in the instructions.

Computer system 100 further includes a read only memory (ROM) 108 or other static storage device coupled to bus 102 for storing static information and instructions for processor 104. A storage device 110, such as a magnetic disk, optical disk, or USB thumb drive (Flash drive), etc. is provided and coupled to bus 102 for storing information and instructions.

Computer system 100 can be coupled via bus 102 to a display 112, such as a cathode ray tube (CRT), liquid crystal display, LED display, or touch screen, for displaying information to a computer user. An input device 114, including alphanumeric and other keys, is coupled to bus 102 for communicating information and command selections to processor 104. Another type of user input device may include a cursor control 116, such as a mouse, a trackball, or cursor direction keys for communicating direction information and command selections to processor 104 and for controlling cursor movement on display 112. The input device may have two degrees of freedom in two axes, a first axis (for example, x) and a second axis (for example, y), that allows the device to specify positions in a plane. In some embodiments, the same direction information and command selections as cursor control can be implemented via receiving touches on a touch screen without a cursor.

Computing system 100 can include a user interface module to implement a graphical user interface that can be stored in a mass storage device as executable software codes that are executed by the one or more computing devices. This and other modules can include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules that can execute on computing devices can be provided on a computer readable medium, such as a compact disc, digital video disc, flash drive, magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

Computer system 100 can implement the techniques described herein using customized hard-wired logic, one or more ASICs or FPGAs, firmware and/or program logic which in combination with the computer system causes or programs computer system 100 to be a special-purpose machine. According to some embodiments, the operations, functionalities, and techniques and other features described herein are performed by computer system 100 in response to processor 104 executing one or more sequences of one or more instructions contained in main memory 106. Such instructions can be read into main memory 106 from another storage medium, such as storage device 110. Execution of the sequences of instructions contained in main memory 106 causes processor 104 to perform the process steps described herein. In alternative embodiments, hard-wired circuitry can be used in place of or in combination with software instructions.

The term “non-transitory media” as used herein refers to any non-transitory media storing data and/or instructions that cause a machine to operate in a specific fashion. Such non-transitory media can comprise non-volatile media and/or volatile media. Non-volatile media can include, for example, optical or magnetic disks, such as storage device 110. Volatile media can include dynamic memory, such as main memory 106. Common forms of non-transitory media can include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from, but can be used in conjunction with, transmission media. Transmission media can participate in transferring information between storage media. For example, transmission media can include coaxial cables, copper wire and fiber optics, including the wires that comprise bus 102. Transmission media can also take the form of acoustic or light waves, such as those generated during radio-wave and infra-red data communications.

Various forms of media can be involved in carrying one or more sequences of one or more instructions to processor 104 for execution. For example, the instructions can initially be carried on a magnetic disk or solid state drive of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 can optionally be stored on storage device 110 either before or after execution by processor 104.

Computer system 100 can also include a communication interface 118 coupled to bus 102. Communication interface 118 can provide a two-way data communication coupling to a network link 120 that can be connected to a local network 122. For example, communication interface 118 can be an integrated services digital network (ISDN) card, cable modem, satellite modem, or a modem to provide a data communication connection to a corresponding type of telephone line. As another example, communication interface 118 can be a local area network (LAN) card to provide a data communication connection to a compatible LAN. Wireless links can also be implemented. In any such implementation, communication interface 118 can send and receives electrical, electromagnetic or optical signals that carry digital data streams representing various types of information.

Network link 120 can typically provide data communication through one or more networks to other data devices. For example, network link 120 can provide a connection through local network 122 to a host computer 124 or to data equipment operated by an Internet Service Provider (ISP) 126. ISP 126 in turn can provide data communication services through the world wide packet data communication network now commonly referred to as the “Internet” 128. Local network 122 and Internet 128 can both use electrical, electromagnetic or optical signals that carry digital data streams. The signals through the various networks and the signals on network link 120 and through communication interface 118, which carry the digital data to and from computer system 100, can be example forms of transmission media.

Computer system 100 can send messages and receive data, including program code, through the network(s), network link 120 and communication interface 118. In the Internet example, a server 130 can transmit a requested code for an application program through Internet 128, ISP 126, local network 122 and communication interface 118. The received code can be executed by processor 104 as it is received, and/or stored in storage device 110, or other non-volatile storage for later execution. In some embodiments, server 130 can provide information for being displayed on a display.

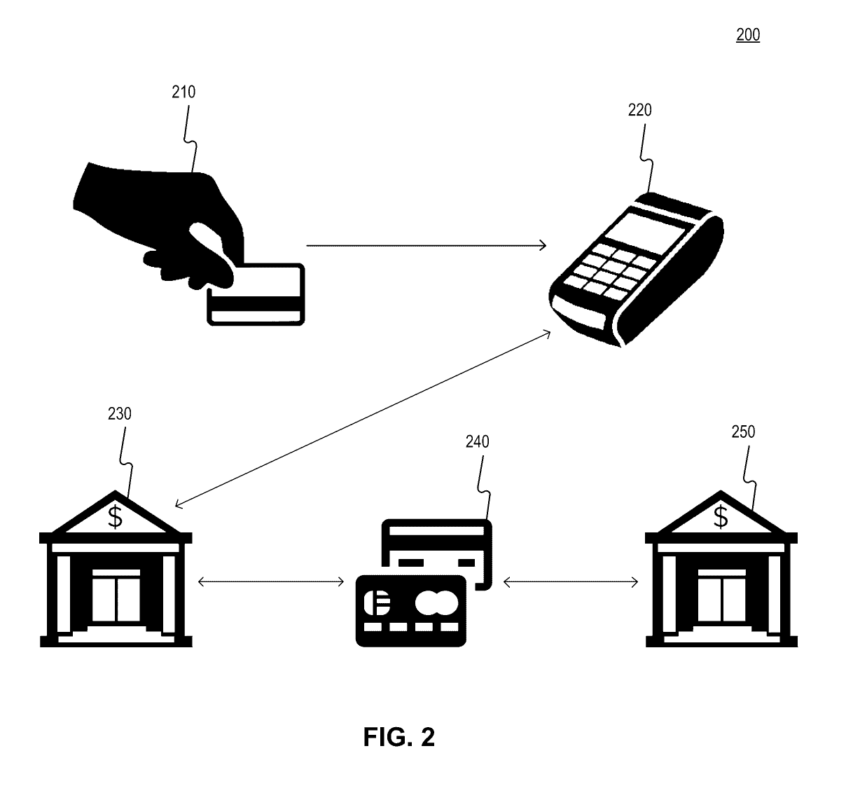

FIG. 2 is a diagram that illustrates an exemplary system 200 used for payment card transactions, consistent with embodiments of the present disclosure. System 200 may include a consumer's payment card 210, a Point of Sale (PoS) system 220, a merchant's third party processor 230, a card association 240, and an issuing bank 250.

Typically, authorization begins at when a consumer's payment card 210 is used at a merchant's PoS system 220. This transaction can occur in a variety of locations, such as at the location of a brick-and-mortar store (e.g., at a kiosk or a register), or online (e.g., at an online store or reseller). After a transaction request is entered into a PoS system 220, a merchant's third party processor 230 may parse information gathered from the consumer's payment card 210 (e.g., the digits on the card) and route the transaction request to an appropriate card association 240. Popular card associations 240 include Visa™, MasterCard™, American Express™ Discover™, etc. The card association 240 may process transaction information to route information associated with the transaction request to a consumer's payment card's issuing bank 250. After an issuing bank 250 determines the account status of a card and verifies that an account has an active status (e.g., the account is has not been deactivated and/or has a particular amount of money associated with it), an approval indicator is sent back to the card association 240, then sent to the third party processor 230, and finally sent back to a PoS system 220. If the consumer's card 210 is declined, a decline message is sent back to the PoS system 220 in the same manner. It should be appreciated that there are a variety of different card authorization and settlement systems and processes, and that this describes one such system. Further, it should be appreciated that although terms such as third party processor and issuing bank are used, various other terms known to one skilled in the art could be used. For example, an issuing bank 250 could also be an issuing financial institution, or the like.

FIG. 3 is a diagram that illustrates an exemplary network environment 300 used for payment card transactions, consistent with embodiments of the present disclosure. Environment 300 includes a network 310, a PoS system 320, a third party processor 330, a card association 340, an issuing bank 350, and a display 360. Similar to system 200, environment 300 illustrates how various portions of a payment card processing system are interconnected. Although not shown in environment 300, additional entities can be communicatively coupled to the entities shown such as an insurance company, a government agency, etc. As shown in environment 300, various portions of a payment card processing system can be located in different locations and coupled together via a network connection, such as over the Internet. In various embodiments, components of environment 300 such as PoS system 320, third party processor 330, card association 340, and issuing bank 350 are electronic devices, which can include at least some of the components described in computer system 100. For example, these components can include a network connection which may include a network interface card, and allows a component to connect to network 310. Components can include one or more processors, such as CPUs, GPUs, and/or DSPs. Further, these components can include memory, displays, I/O devices, etc. In some embodiments, these components can include a single electronic device, or multiple electronic devices such as a cluster of computers. In some embodiments, these components can include a stateless device such as a virtual machine.

With current card payment systems, cards are typically flagged as being compromised after they have been used by an unauthorized user. As discussed above, embodiments described herein attempt to identify compromised cards prior to their use, in large part by identifying whether a card was used at a merchant on a date when a breach is suspected to have occurred.

Typically merchants do not know that they have been breached until the cards are used at various stores, there are recognized indicators of breaches, or they are notified of a suspected breach (e.g., by the card holder or a financial institution). Use of stolen cards is referred to as cashing out. Merchants may become aware that their systems have been breached by a bank notifying them of a number of fraudulent activities occurring by cards that may have been used at a particular merchant's store, and/or within a particular time period. The particular merchant, or their store, is sometimes referred to as a Common Point of Purchase (CPP). Since there is an incentive for merchants not to disclose that their systems have been hacked, many merchants (and/or financial institutions) would rather know that cards have been compromised before they are cashed out. Of course, in some scenarios merchants may have an incentive to publicize a hack (e.g., due to particular laws), in which case they certainly want to learn of the hack before cards are cashed out.

As described in various embodiments herein, a compromised card can be identified prior to being cashed out. In some embodiments, once a card is identified as being compromised, it can be deactivated or otherwise have its status changed to prevent cashing out. As described above, pre-emptively determining whether a card was potentially compromised can be difficult. However, patterns (or trends) indicative of a compromised card can be determined. For example, information indicative of fraudulent activity may include a card being used at a particular number of merchants within a particular amount of time (e.g., 5 or more merchants within twenty minutes) may be indicative of a compromised card. As another example of information indicative of fraudulent activity may include a card being used at a variety of unrelated merchants (unrelated by geography, type of merchant, goods the merchants sell, etc.) within a particular period of time. For instance, a card may be used at a pizza store, a shoes store and an online auto-part store within a particular period of time. Or, as another example, a card may be used at restaurant in California and a store that sells snowboards in Colorado within 5 or 10 minutes of each other.

If a particular merchant is identified as being the source of a breach, then all cards used at that merchant can have their status changed as potentially being compromised. In some embodiments, a date or set of dates can be determined, such that only cards used on that date or within those set of dates have their status changed. Moreover, in some embodiments, methods and systems can be implemented that allow an insurance company to modify information it associates with a particular merchant. For example, if an insurance company receives data indicating that a particular merchant is the source of a breach, the insurance company may determine that the particular merchant's insurance should be adjusted. As another example, a whole class of retailers may have their insurance adjusted (e.g., retailers that do not use particular breach detection measurers, such as those described in the embodiments herein). Further, in some embodiments, an insurance company may adjust rates associated with particular merchants in a particular area based on the determination of one or more breaches. Similarly, insurance companies may change rates associated with merchants that sell similar goods or services based on the breach. For example, in some embodiments, if an insurance company receives information indicating an ice cream store in Miami, Fla. is the source of a card breach, the insurance company may adjust its rates associated with other ice cream stores and/or other companies located near the breached ice cream store. By adjusting rates, insurance companies may be able to diminish the impact of claims they are subject to resulting from credit card breaches.

Of course, not all merchant health/breach scores may be acted upon by insurance companies alone. As described in association with the approaches above, merchants and their relevant statistics can be provided in a dossier (e.g., an amount of cards used at a merchant that change in status, the volume of cards a merchant processes, the time a merchant opens their store, etc.). Systems within a financial institution such as a card issuer and/or a card association, or an analyst working within either, can take actions including, but not limited to: (1) closing the merchant and all cards—such that the merchant can no longer process transactions using some or all cards and/or some or all cards used at the merchant can be reissued; (2) closing the merchant—such that the merchant can no longer process transactions; and (3) take no action—such that the merchant can continue to process cards. As described above, such actions made regarding merchants rather than individual cards can increase the efficiency and efficacy of counteracting fraud by shutting down a particular merchant and/or at least some of the cards used at that merchant.

As briefly discussed above, in some embodiments a card association 340 may be notified if a breach has occurred in addition to/or without notifying a financial institution and/or insurance company. In such an example, a card association 340 can alert merchants, one or more financial institutions (e.g., a card issuer or a merchant's bank), one or more card holders, etc. In some embodiments, a card association 340 will be able to determine the card holders, the potentially breached merchants, the issuing banks, the merchant banks, the insurance companies associated with a merchant and/or bank, etc. Similar to insurance companies, card associations 340 may be able to determine a breach score associated with particular merchants or types of merchants, and adjust their fraud monitoring behaviors accordingly.

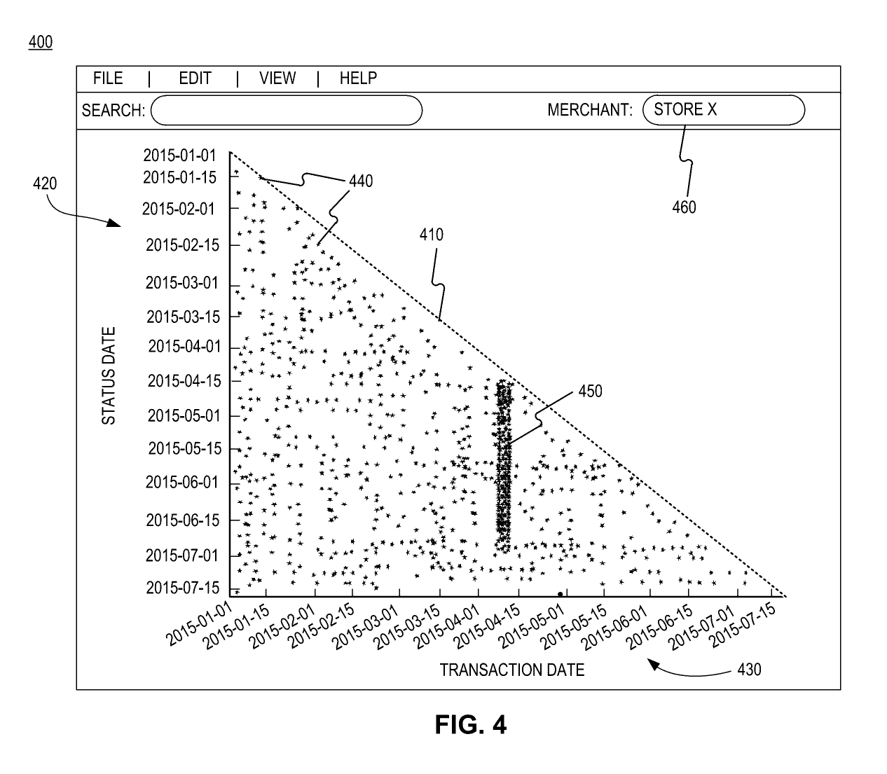

FIG. 4 is an illustration of an exemplary interface 400 for identifying potential information related to payment card breaches, consistent with embodiments of the present disclosure. In some embodiments, interface 400 can be provided on display 360 (as shown in FIG. 3). Display 360 can be coupled with various electronic devices, such as computer system 100 (as shown in FIG. 1), a server, a cloud environment, and/or various other electronic devices. Interface 400 illustrates a graph 410 that can be used to pre-emptively predict card breaches associated with one or more merchants. Graph 410 comprises a Y-axis that indicates a change in the status (or card health) of a payment card on a particular date 430, and the X-axis indicates the transactions that occurred on a particular date 430. In some embodiments, the graph 410 can indicate the health of a cards used in transactions at a particular merchant (e.g., Store X). Interface 400, as well as other interfaces described herein, may indicate the merchant being analyzed using a widget 460 such as a text box or drop-down menu. It should be appreciated that herein, the term merchant can be used interchangeably with a group of merchants, a particular location of a particular merchant, a particular network device/product (e.g., a particular cloud environment, service provider, domain server, etc.), a particular department of a particular merchant, a particular subsidiary of a particular merchant, etc.

Graph 410 also includes a variety of points that indicate a change in the status/health of a payment card (status-change points 440) with reference to the date a transaction was made. In addition, graph 410 includes a period of time where there is a concentration 450 of status-change points 440. Status-change points 440 may indicate payment cards that were declined, were cancelled, flagged as potentially being compromised, deactivated, flagged as suspicious, or another type of change in their card health value, etc. In some embodiments, status-change points 440 can be weighted (and/or included or not included in a graph) based on a variety of attributes associated with a payment card including whether a payment card was deactivated due to a cardholder changing their name, a cardholder reporting fraudulent activity, a cardholder losing their card, etc. In some embodiments, a card's health/status can be re-determined (e.g., the graph can be refreshed), and in turn, a graph or pattern might change.

As illustrated, graph 410 may include transactions that occurred at Store X with a particular set of payment cards. Merchants to analyze may be selected using a menu, search mechanism, or other type of widget 460 in an interface 400. It should be noted that interface 400 can be displayed on a variety of devices, including, but not limited to: mobile electronic devices, smart phones, wearable computers, tablets, devices with touch screens, laptops, desktop computers, etc.

Returning to graph 410, various status-change points 440 are determined based on two dates: the date a transaction occurred, and the date a change in a particular card's health changed. In some embodiments, after a particular merchant is selected, cards used in transactions at that merchant occurring between a set of dates may be determined. If one of those cards experiences a change in its health within the dates shown on the Y-axis of the graph, a dot may be plotted indicating the date of the transaction and the date of the change in card health. For example, a card that was used on Jan. 15, 2015 at a particular merchant may have its health changed on the same day. If so, a status-change point 440 may be plotted on the hypotenuse of the right-triangle illustrated in graph 410. As should be apparent, graph 410 is shaped like a triangle because approaches described herein are not concerned with cards that experienced changes in their health before a particular transaction occurred. Thus, the Y-axis is shown in reverse chronological order as a transaction that occurred on Jul. 15, 2015 (the highest value on the X-axis) could not have a relevant change in health prior to Jul. 15, 2015 (the lowest value on the Y-axis). In some embodiments, more points may be plotted and/or a graph may change its scale as time passes. For example, a card used to make transactions that occurred on Mar. 1, 2015 may not have status-change points 440 associated with the card until April or May 2015, when the card's health changes (note that as time advances, the status-change points 440 associated with a transaction would appear lower on graph 410 since the Y-axis is in reverse chronological order).

As another example shown in graph 410, there is a large concentration 450 of status-change points 440 associated with transactions that occurred shortly before Apr. 15, 2015. This can be indicative of a breach occurring at the transactions date(s) corresponding to this concentration 450. As shown, before Apr. 15, 2015, multiple transactions occurred at Store X with cards that subsequently changed their respective statuses. These changes in status/health occurred between a date after Apr. 1, 2015, until about Jul. 1, 2015. The change in statuses decreased after Jul. 1, 2015—as shown by the decreasing amount of status-change points 440 near the bottom of the concentration 450. This might be because the majority of compromised cards were deactivated or not used as the time following the potential breach increased (e.g., most cards that were compromised in a breach before Apr. 15, 2015 were likely used, deactivated, or otherwise changed their health soon after the breach occurred).

Thus, graphs indicating patterns (e.g., concentrations 450) can be used to determine breaches that may have occurred at a store (e.g., Store X) at an approximate date (e.g., near the beginning of April, 2015 as shown on the X-axis). These patterns can be determined in a variety of ways, such as by a user viewing a display (e.g., display 360), or by a pattern recognition algorithm. It should be appreciated that a pattern recognition algorithm may not require a graph to determine whether a potential breach has occurred, and instead may use other inputs.

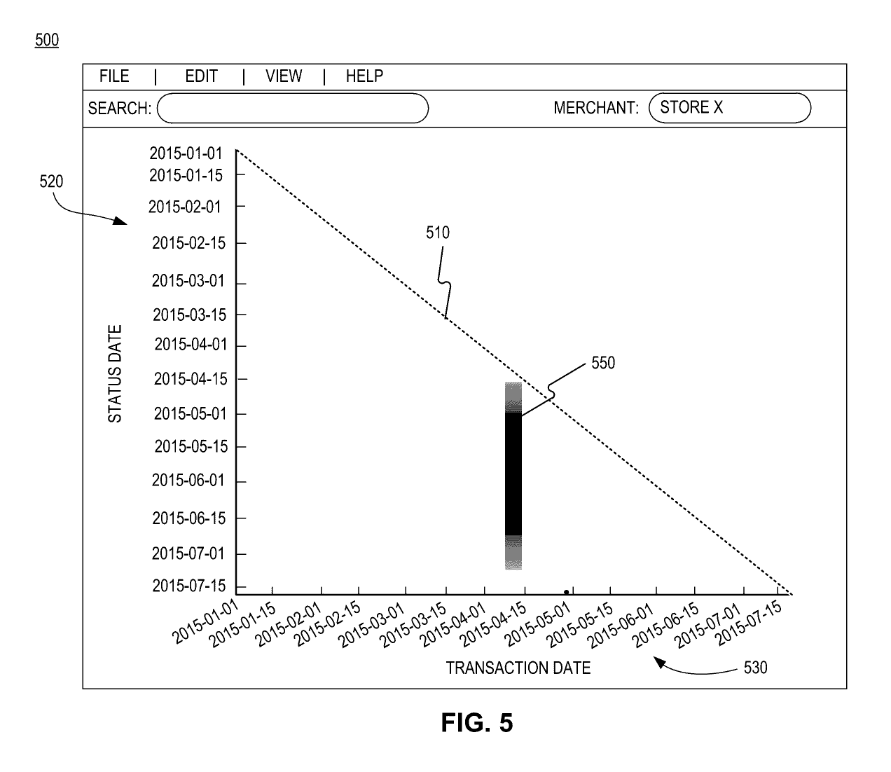

FIG. 5 is a diagram of an exemplary interface 500 for identifying potential information related to payment card breaches, consistent with embodiments of the present disclosure. Interface 500 includes a graph 510 in the shape of a triangle. The Y-axis of graph 510 indicates status dates 520 associated with payment cards and their health values, and the X-axis of graph 510 includes transaction dates 430 associated with payment cards. Similar to graph 410, graph 510 includes a conspicuous band 550 indicating the time, or range of dates, of a potential breach at Store X.

In graph 510, potential breaches appear as a band 550 on the graph between two dates. As described above, various systems and methods can be implemented to identify breaches. For example, in some embodiments a system can recognize that there was a lapse prior to the cards being breached and the cards' status changing. Similarly, systems can use information associated with the number of cards (e.g., as illustrated by the concentration of status-change points in relation to a transaction date in graph 510) that changed statuses to determine that a particular store was where a particular breach occurred. That store may be labelled as a common point of purchase (CPP).

As described above, approaches described herein can be implemented with regard to personal identifying information (PII). PII can be acquired with, or without card transactions. PII can be acquired from a variety of entities that receive, acquire, or request PII. For example, a transaction may include a request for a credit report where a user enters various PII. The PII may include a social security number, an address, a phone number, health information, employer information, information associated with family members, information associated with various payment accounts such as a loan, an online payment service, a phone bill, etc. As additional examples, PII can be acquired from a health care provider, an employer, a bank, etc.

In various embodiments, similar to the card breach detection approaches described herein, a set of known transactions (which, for this approach may be a request for a credit report or accessing health records, etc.), can be compared to a set of known compromised PII. By using an approach similar to those described herein, compromised entities (e.g., an employer or a health care provider) can be flagged as being potentially compromised. For example, if many social security numbers are suspected of being potentially compromised (e.g., acquired in an unauthorized manner), the dates that the social security numbers were found to be potentially compromised can be compared with various entities or transactions (e.g., requests for credit reports or heath records). As with a payment card, it may be possible to determine a potential source of a breach based on the dates various PII was acquired by an entity and the dates on which that PII was flagged as being compromised. It should be understood that the term “flagged” may refer to a change in the status/health of a person, PII, a social security number, a payment card, etc. In some embodiments, set of known transactions and the set of known compromised PII could be stored by the same entity. For example, a credit reporting company could be both the source of transactions which may have been breached and be store a set of known compromised PII (e.g., a set of social security numbers or people/entities associated therewith that may have been compromised). Although much of this application refers to payment card breaches, it should be appreciated that PII breaches can be detected, determined, estimated, etc. in the same methods and by the same systems as described herein with reference to payment card breaches. For example, status-change points could include applications for credit cards, requests for credit reports, requests for identification cards, etc. If a particular amount of applications for credit cards are associated with a particular set of social security numbers (e.g., social security numbers belonging to a particular amount of employees at a particular company), embodiments described herein may notify an employer or other entity that a potential breach of PII has occurred.

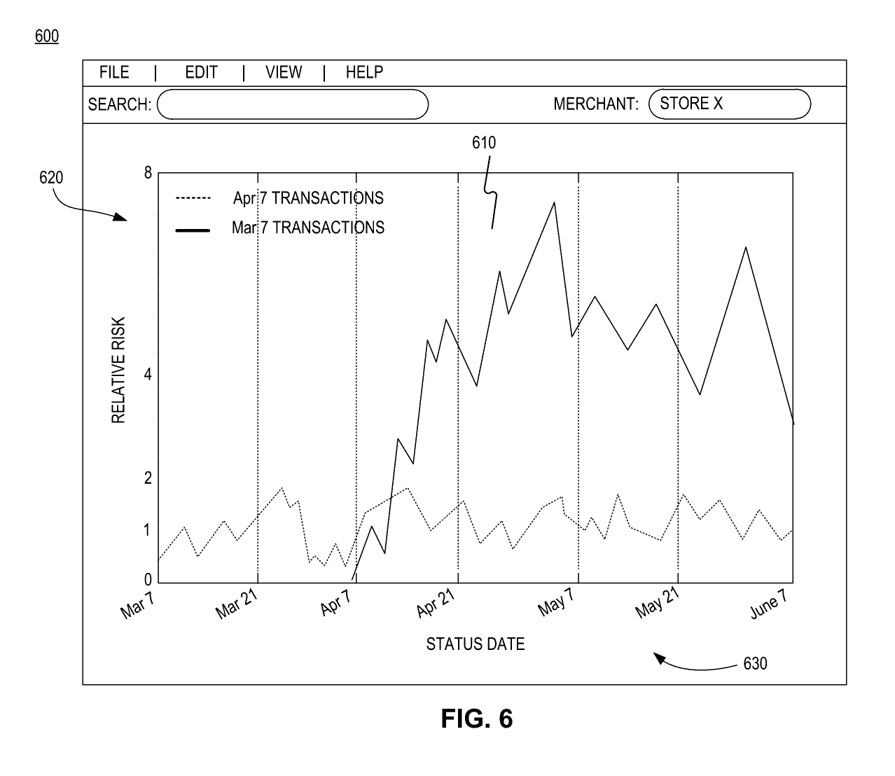

FIG. 6 is another illustration of an exemplary interface 600 for identifying potential information related to payment card breaches, in accordance with embodiments described herein. Graph 610 includes a Y-axis that indicates the relative risk 620 (e.g., probability that a card's associated health will change) associated with the payment cards used in transactions at a particular merchant, and an X-axis that indicates points in time 630 and the relative risk of cards being compromised based on the date that they were used in a transaction. Graph 610 roughly corresponds to graphs 410 and 510. As can be seen, graph 610 indicates card transactions that occurred on April 7 (near early April as in graphs 410 and 510), and the relative risk associated with those cards as time passes. Graph 610 can be useful as a user can compare the relative risk of cards that were used in transactions at Store X on April 7 to the relative risk of cards that were used in transactions at Store X on March 7. As can be seen by an analyst, the relative risk of cards used in transactions on April 7 is much higher than those used in transactions on March 7. Thus, the system can automatically perform risk analysis by predicting in advance the likelihood that a card used in a transaction on a particular date at a particular merchant will be compromised—thus solving the problem with current breach detection systems. As illustrated in graph 610, it is clear that cards used in transactions on April 7 at Store X are much more likely to experience a change in their health score and/or be compromised than cards that were used in transactions at Store X on March 7.

In some embodiments, various types of entities can make use of the disclosed systems. For example, merchants or a card issuing banks can use the systems and methods described herein to determine potential breaches and their potential locations prior to the cards being cashed in. In some embodiments, potential breach locations can be determined by a system, and a list of those locations created by the systems and methods described herein can be provided to one or more users (e.g., merchants or banks). After, a bank can take any of a variety of actions based on the information provided by the systems and methods described herein, such as deactivate all of the cards that were used at a particular location (also referred to as a common point of purchase, or CPP). In some embodiments, a list of cards that were used at potential CPPs can be provided to users, merchants, banks, etc., such that those cards can be deactivated or used for another purpose (e.g., to further detect fraud). In any case, by providing a user with the ability to determine that cards have potentially been compromised, the system can allow a user to prevent the card from being cashed out.

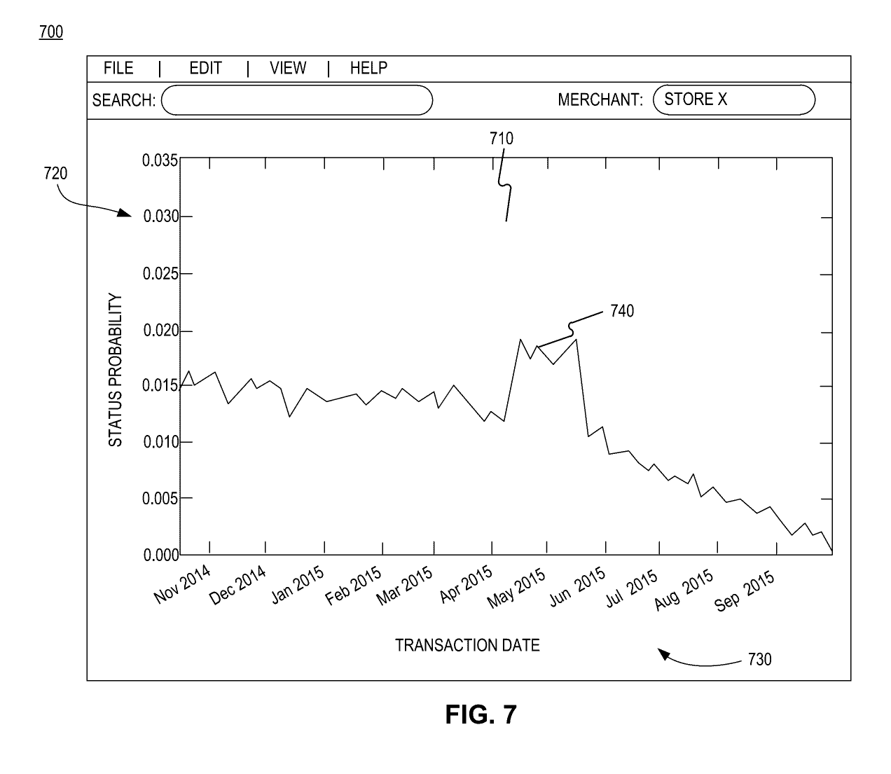

FIG. 7 is another illustration of an exemplary interface 700 for identifying potential information related to payment card breaches. Graph 710 included in interface 700, however, illustrates a line graph including a Y-axis that indicates the probability that a status of one or more cards (interchangeably referred to as the health of one or more cards) has changed or not changed, and an X-axis that indicates the date that a transaction occurred on. Graph 710 also includes an abnormal spike 740 that occurs around April and May of 2015. This spike 740 can be indicative of an increase in sales at a particular merchant. For instance, this spike 740, which indicates a change in the status probability of a set of cards, could be indicative of more shoppers during a particular time of year. Alternatively or additionally, a spike 740 could be indicative of an association, a third party processor, or a card issuing bank changing its system (e.g., a code associated with a merchant) such that a spike 740 indicating a change in status occurs. Abnormalities such as spike 740 may be indicative of false positives (e.g., indications that cards may have been compromised when they were not). False positives can be common, and can be decreased by weighing transactions or attributes of transactions based on the time of year, a geographic location, a change in the systems of a card issuer, etc. Similarly, false positives can be reduced by comparing a set of values or a graph to a baseline, which in the case of graph 710 may indicate that there is always a spike around April and May, often causing false positives.

As described above, transactions may be weighted and/or filtered for significance. For example, if a particular card association, merchant, or issuer bank causes false positives, transactions associated with that association, merchant, or bank may be given less weight than an association or bank that produces more reliable results. Similarly, abnormal amounts of sales during April or May may be given less weight than other days, and thus filtered when a system is attempting to determine potential breaches. Moreover, different weights may be given to different types of cards used in transactions (e.g., cards with microchips in them). In some embodiments, different weights associated with changes in card health can be based on a type of merchant. For example, if a card is being used on a cruise ship, changes in card health that may be associated with using a card in a different country may be filtered or otherwise ignored.

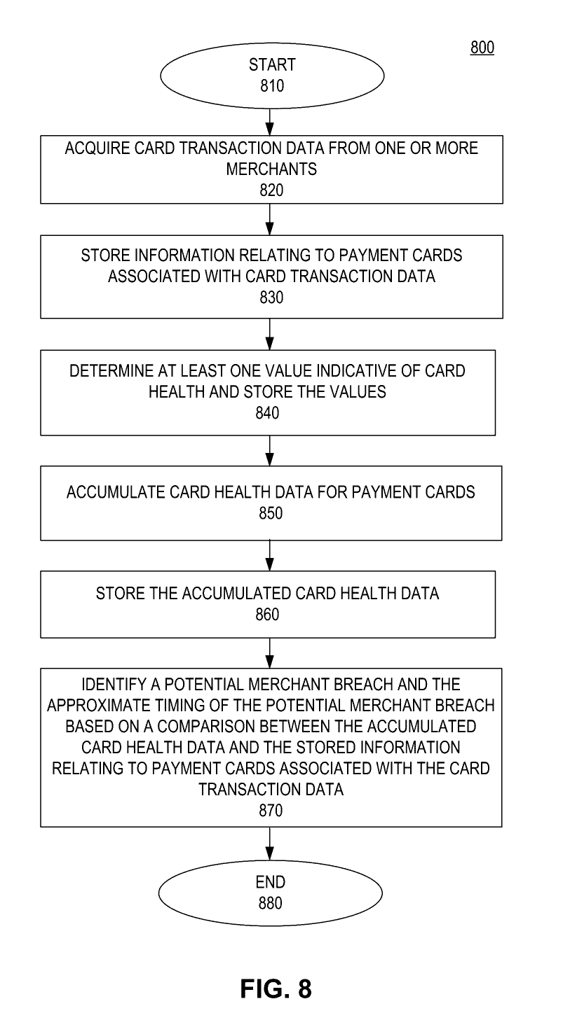

FIG. 8 is a flowchart 800 representing an exemplary method for identifying a potential merchant breach. While the flowchart discloses the following steps in a particular order, at least some of the steps can be performed in a different order, performed in parallel, modified, or deleted where appropriate, consistent with the teachings of the present disclosure. Further, steps may be added to flowchart 800. The method can be performed in full or in part by a system as described in the embodiments discussed above. In addition or alternatively, some or all of these steps can be performed in full or in part by other devices and/or modules.

Flowchart 800 starts at step 810 and at step 820 acquires card transaction data from one or more merchants. In various embodiments, this data can be acquired automatically. The data can be acquired via a data interface, which in some cases allows for the acquisition of card transaction data automatically. It should be understood that card transaction data includes transaction data as discussed throughout the instant disclosure, and vice-versa. In some embodiments, card transaction data acquisition is performed at a particular time interval, which can be predetermined or based on attributes such as the time of year or if an increase in card breaches elsewhere are known to exist. For instance, card transaction data can be acquired once an hour, once a day, once a week, etc. It is further contemplated that card transaction data can be acquired in real time or near-real time, such that a system or method can perform real time or near-real time analysis. Further, card data can be pushed to a system by a merchant, or pulled by a system (e.g., a system may poll merchants for card transaction data). It should be appreciated that systems described herein can gather transaction information associated with billions of transactions from around the world very frequently (e.g., once a day or more). Systems described herein can then use various methods, as described herein, to quickly decipher information associated with transactions, such as whether to weight them or not, and process tens of billions of transactions quickly (e.g., in real- or near-real time). The acquisition of data can occur every day, and when combined with the stored transactional data, patterns or other indications of breach may be determined by such systems. In other words, systems described herein can significantly reduce the amount of computer resources and/or network bandwidth required to process card transactions and determine the probability of a breach, in order to prevent the significant amount of problems caused by not determining a breach until after cards have been cashed out.

At step 830, information related to payment cards associated with the transaction data is stored. This information can be stored in a variety of places, such as within the system before processing, or in a network storage device (e.g., a multi-tenant system such as a cloud). In some embodiments, information can be stored on various virtual or non-virtual devices (e.g., stateless machines), and/or some or all of the processing associated with systems and methods described herein can be performed in on a stateless machine.

At step 840, at least one value indicative of card health is determined and stored for at least some of the payment cards (e.g., the payment cards associated with the card transaction data acquired from the one or more merchants in step 820). This step can also be performed automatically, and occur in real or near-real time. As discussed above, the acquired data can be stored at a system or off-site in some type of network storage device. In some embodiments, the determination of the values indicative of card health is performed at a predetermined time interval (also referred to as a periodic interval, which can include uniform periods or dynamic periods). In some embodiments, card health can be obtained in any suitable manner. In some embodiments, the card health information may be obtained by the card issuing entity, banks, etc. Other services may also be available that can track card health and provide health information. In some embodiments, the approaches described herein used for determining health scores associated with card (or merchants) can be based at least in part upon a card that has been declined. Such a card could assist any of the techniques described herein with determining a common point of purchase (e.g., a breach), or a pattern indicative of a breach and/or card testing more accurately.

At step 850, the card health data for payment cards is accumulated. This can occur over a predetermined period of time (e.g., a day, a month, etc.), and/or can occur automatically. Further, the card health data that is accumulated can be based on the value(s) indicative of card health, as determined in step 840. As described above, card health can include a variety of card attributes (such as whether a card has been declined), and the value of card health can be based at least in part on one or more attributes associated with a card, such as the likelihood that a card has or has not been compromised, whether a card is active or inactive, whether a card has been declined or will be declined, the remaining balance on a card, the spending limit associated with a card and whether that limit has changed (e.g., within the last month), etc. The accumulation of card health data for payment cards can include the card health data for at least some of the cards within a predetermined amount of time (e.g., the last three months or year), or it can be based at least in part on an amount of cards (e.g., 10,000, 100,000, or 10,000,000,000, etc.). In some embodiments the amount of information accumulated can be predetermined by a user, or it can be determined by an amount of storage available. Further, this accumulation can occur in real or near-real time, as with the other steps described herein.

At step 860, the accumulated card health data is stored. This data can then be manipulated to determine patterns, such as those described above. The accumulated data can be stored automatically, and can be replaced the next time data from a merchant is received and card health scores are calculated. In some embodiments, it is contemplated that merchants may provide information associated with card transactions and/or cards where a health score has not been determined. In such a scenario, newly determined health scores can be determined iteratively and added to the accumulation of card health scores in real or near-real time. This can reduce the amount of processing or resources required by a system as only new cards need to have their card health values calculated.

At step 870, a potential merchant breach is identified and an approximate time of the potential merchant breach is determined based on a comparison between accumulated card health data and stored information related to payment cards associated with the acquired card transaction data. For example, as a method or system accumulated card health data for payment cards, it may determine that one or more cards' health scores decreased after a particular time and/or date. This time and/or date can be used to determine the time of a potential breach. In addition, based on the number of cards with decreases in card health values, an estimate can be made as to whether the particular merchant supplying the transaction information was breached, and/or possibly what merchant may have been breached. In some embodiments, departments or sub-PoS systems associated with a merchant can be determined to have been breached.

At step 880 flowchart 800 ends.

### Card Testing Detection

In addition, embodiments of the invention described herein relate to a card testing identification system that determines whether a payment card has been tested by an unauthorized user, typically prior to a tested payment card being printed and used illegally. Such card testing can be indicative of a breach, and thus embodiments describing card testing detection can be used to assist in determining a breach. In various embodiments, patterns (which can be displayed as graphs) can be used to determine whether cards were used at a test site. In some embodiments, cards that are known to have been compromised can assist with determining whether cards were used at a test site. After a test site is known, cards used at that test site can be used to determine a merchant that had a breach. In response to a known (or potential) merchant breach, various entities such as card issuers can take a number of actions with regard to the merchant and the cards used at that merchant.

Card testing identification systems described herein may provide a user with various information. For example, the identification of testing sites, and potentially compromised cards may be generated and provided to a user. Similarly, a list of known testing sites (e.g., fake merchants or real merchants used without their knowledge) may be created and maintained. It should be understood that, in some embodiments, a card testing site is not a physical location but rather one or more networked electronic devices, which may share a common identifier. Card testing identification systems may also provide various users, card issuers, or other entities with an ability to discover testing sites themselves. In various embodiments, a system that provides information associated with tested cards and/or information associated with testing sites may be associated with a particular interface or portion of an interface.

Identification of card testing and card testing sites may be accomplished using various techniques. For example, recognized transaction patterns may indicate card testing. Such patterns may include transactions where a dollar amount is zero; transactions for very small amounts; multiple transactions of increasing amounts; transactions close in time but spaced apart geographically (e.g., within an hour of each other and over 100 miles apart); and others may all indicate the presence of card testing activity. In some embodiments, machine learning (e.g., making future predictions based on past events) can be used to determine new patterns. In addition, in some embodiments, a card that is known to have been compromised can be used to determine a testing site. Such a card can potentially have a testing site associated with its previous transactions.

In some cases, card testing may occur across many test sites (including one or more merchants that have been hacked and used for testing without their knowledge). A test site, also referred to as a testing site, can employ a fake merchant name, which might exist for a few days before disappearing. In any of these embodiments, the test site can then be identified, as its name will appear on all cards that are subsequently found to be compromised. This name (which may be a merchant) can then be flagged as a potential test site, and cards that have been used by that test site can be deactivated. In some embodiments described herein, a test site can refer to a single Point of Sale (PoS) system, or more than one PoS systems that are related.

Further, card testing identification systems described herein can provide percentages or confidence levels associated with potential testing, since in many instances it may not be clear whether testing occurred or some atypical spending behaviour occurred.

In some embodiments, examples of known testing patterns can be used to uncover unknown testing. Further, newly discovered testing techniques can be used to determine future testing. For example, in some embodiments, a set of testing patterns may be stored in a database or some other data structure. Such a set may include patterns indicative of testing as described above (e.g., transactions for very small amounts, multiple transactions of increasing amounts, etc.). In addition to the patterns included in these sets, additional patterns can be added to these sets as new testing patterns are determined. For example, after machine learning may be used to discover and/or add new patterns indicative of testing to a set of patterns. From that point forward, various systems may use the new pattern(s) to assist in monitoring cards/determining potential test sites.

In some embodiments, potential patterns can be marked, or otherwise designated/flagged by a human or machine prior to being added to a set of patterns that may indicate potential testing. In some embodiments, if a pattern begins to emerge, a system may indicate the emergence of a pattern to a human that in return can provide input to a system indicating that (1) the pattern is indicative of testing; (2) the pattern is likely indicative of testing (e.g., the input may include a probability that the pattern is indicative of testing); or (3) the pattern is not indicative of testing. Such human intervention can be used to save time, as a human may be able to help a system determine testing before the system would be able to on its own. Further, in some embodiments a human may be able to provide input to a system indicating that a pattern should be included in a set of patterns (also referred to as rules), or that the pattern should not be included in a set of patterns.

In some embodiments, information associated with cashing sites may be used to determine a breach and/or a testing site. For example, if particular activity is known to occur when a card is cashed at a particular merchant or type of merchant, such activity may be flagged as indicative of testing. For example, if one card of a set of known cards is cashed at a particular merchant or set of merchants, other cards in that set of cards may be flagged as being compromised before they may be cashed. As described above, not only may other cards in that set be deactivated due to the cashing, but law enforcement may be notified, a merchant may be notified, a card association may be notified, and/or a financial institution may be notified. As described herein, a merchant can have their status changed as potentially being compromised. In some embodiments, a date or set of dates can be determined, such that only cards used on that date or within those set of dates have their status changed.

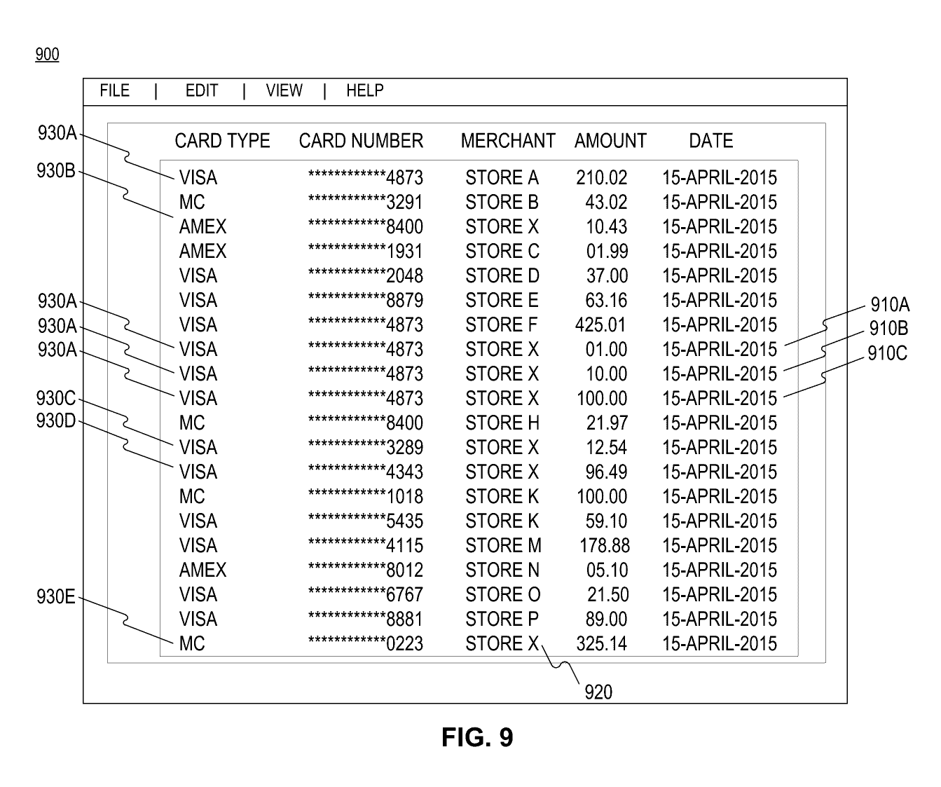

FIG. 9 is an illustration of an exemplary user interface 900 for identifying potential tested cards and/or test sites, consistent with embodiments of the present disclosure. User interface 900 includes a list of transactions, including some that may be indicative of card testing (e.g., transactions 910A, 910B, and 910C (collectively 910)). User interface 900 includes the names of merchants (which may be potential test sites), such as potential test site Store X 920. The list of transactions shown in user interface 910 also includes cards that have been used at potential test site Store X 920 (e.g., the cards associated with transactions 930A, 930B, 930C, 930D, and 930E (collectively, 930).

In some embodiments, a user interface 900 can include some or all transactions associated with a card type, card number, merchant, amount, date, and/or other attributes. User interface 900 also can sort various transactions based one, two, or more attributes. Although the user interface 900 is not always necessary to perform various actions as described herein, in various approaches patterns such as the increasing amount in money spend in transactions 910 can be identified, and associated with potential test site Store X 920. As a response to determining potential test site Store X 920, other cards that were used at Store 920 can be identified (e.g., the cards associated with transactions 430). In addition to changing the health scores associated with these cards, as discussed above, a merchant such as Store X 920 may have its health score changed. In some embodiments, all cards that were used at Store X 920 may be deactivated, or otherwise flagged as being potentially compromised. In some embodiments, in response to determining that Store X is a potential test site, a card association or card issuer may not allow cards to be used at Store X. Of course, patterns other than an increasing amount of money spent as illustrated by transactions 910 can be used to determine a potential test site.

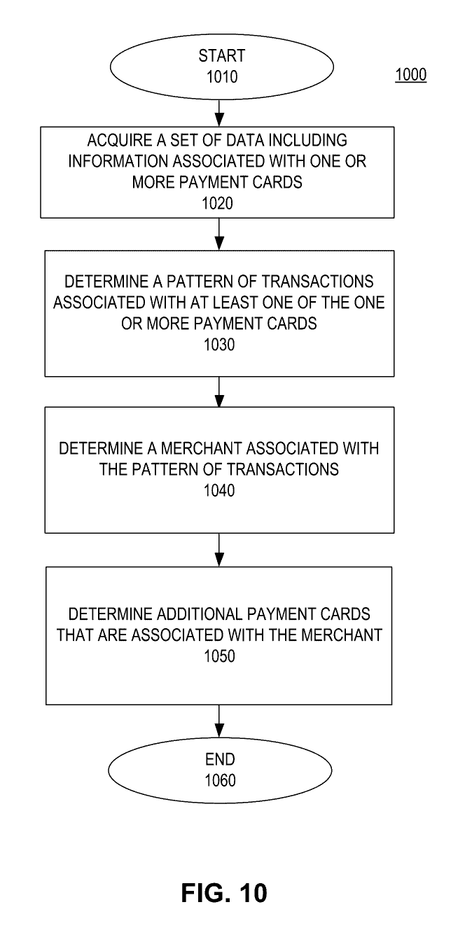

FIG. 10 is a flowchart representing an exemplary method for identifying potentially tested payment cards and/or test sited, consistent with embodiments of the present disclosure. While the flowchart discloses the following steps in a particular order, at least some of the steps can be performed in a different order, performed in parallel, modified, or deleted where appropriate, consistent with the teachings of the present disclosure. Further, steps may be added to flowchart 1000. For example, a step that prevents cards being used at a particular merchant that is a potential test site can be added. The method can be performed in full or in part by a system as described in the embodiments discussed above. In addition or alternatively, some or all of these steps can be performed in full or in part by other devices and/or modules.

Flowchart 1000 starts at step 1010 and at step 1020 acquires a set of data including information associated with one or more payment cards. The information associated with one or more credit cards can include a variety of useful data used to determine whether a card has been tested, and potentially the identity of a test site. Such information can include identifying information such as the name of a bank that issued the card, the name of a third party processor, the name of a cardholder, the name of a merchant. The information can also include information corresponding to particular transactions, such as an amount of money spent, the time of a transaction, the physical location of the transaction if available, an Internet Protocol (IP) address of one or more machines used in or associated with a transaction, etc.

At step 1030 a pattern of transactions associated with at least one of the one or more payment cards is determined. As discussed above, information associated with transactions may be gathered from various sources including a company, a bank or other financial institution, a card association, etc. Based on the information associated with multiple transactions, a pattern can be determined. A pattern can be a particular number of cards used within a particular time period, and/or a particular number of cards used at a particular location. Additional transaction patterns indicative of card testing can include patterns indicating that multiple transactions are made in a short period of time (e.g., 20 transactions within 1, 5, or 10 minutes). In particular, such a pattern may be determined and/or given greater weight than other patterns if it occurs at more than one merchant in a particular period of time (e.g., where a first transaction occurs at a pizza store, a second transaction occurs at a book store, and a third transaction occurs on a website—all within 3 minutes). Another example transaction pattern includes many transactions where the amount is $0.00. Transaction patterns can also include transactions wherein each transaction increases by a small amount in chronological order (e.g., $0.01, $5, $10, $100, $1,000; or $0.00, $0.01, $0.02, $0.03, etc.). Such a pattern may be indicative of a device testing a card to determine its limit. Another example transaction pattern includes cards being used at the same store(s), or a set of stores in a particular geographic region. For instance, if a batch of cards are all used at least at a particular set of stores in Virginia, that batch may be flagged as being compromised. In some embodiments, as new patterns are discovered, they may be saved and used at a later time to determine potential testing sites. Another example transaction pattern can include one or more transactions that were declined (e.g., a transaction for $5,000 that was declined, followed by a transaction of $1,000 that was declined, and/or followed by a transaction of $500 that was not declined). This type of pattern may be indicative of someone attempting to determine the limit on a card. Another pattern could include the duration of the existence of a particular testing site (which could be a merchant). For example, if a card is used at a merchant which is known to only exist for 3 days, that merchant may be flagged as a testing site and/or part of a pattern. Of course, some transactions may be filtered or discarded by approaches described herein to rule out false-negatives. Additionally, any of the example patterns described above can occur at (or be indicative of) one or more testing sites.

In some embodiments, transaction patterns can be weighted. Since transactions included in patterns may be indicative of a false-positive or a false-negative, a pattern can be weighted based on the likelihood that the pattern is, in fact, indicative of a payment card being tested. For example, a pattern may be associated with a numerical likelihood that it is indicative of a merchant breach (e.g., 0.3, 0.5, 0.7, 0.9, etc.). Further, as described above, new patterns can be determined by systems described herein. When a set of cards is determined to be compromised, the transactions associated with them can be analyzed to determine potential patterns indicative of testing. Such patterns can then be added to a set of patterns that may be compared to various sets of card transactions.

At step 1040, a merchant associated with a pattern of transactions is determined. After identifying one or more of the patterns as described above, one or more merchants can be determined that are associated with the breach. For example, if all transactions included in a pattern were performed at a single merchant, then that merchant may be a testing site. It is helpful to keep in mind that the merchant may be a real, physical or online retailer, or it could be a phony merchant created by counterfeiters for the purpose of testing payment cards—which can be done using a computer or set of computers unassociated with a brick and mortar store. In some embodiments, one or more merchants can be included in a set of transactions included in a pattern. In such a case, one or more of the merchants may be flagged as potential testing sites. In some embodiments, supplemental information can be used to assist in determining one or more particular merchants that are likely to be testing sites. For example, cards that are known to have been compromised that were used in transactions at one or more of the merchants included in a pattern can be used to determine a particular merchant out of the many included in a particular pattern. As another example, information indicating that a particular merchant is a real merchant and not a testing site can be used to assist with determining that another merchant associated with the pattern of transactions is indeed a testing site. In some cases, a card association or card issuer may adjust a health/fraud score associated with that particular merchant, or stop cards from being used in transactions associated with the merchant (e.g., transactions at that particular merchant, transactions a subsidiary or sister company of that merchant, other merchants using the same card processing systems, or similar card systems (e.g., card systems provided by the same third party processor). In some embodiments, the adjustment of the health/fraud score of a merchant or the prevention of cards being used at a particular merchant can be based on a ratio of an amount of cards used at that merchant to the amount of cards that had their statuses changes or were deactivated, a ratio of how much money is spent at the particular merchant to how much money was stolen by testing or cashing in, etc.

At step 1050, additional payment cards that are associated with the merchant are determined. If the merchant is likely a testing site, other card holders, banks, third party processors, card associations, or other interested entities would likely want to receive information indicating that the merchant is a likely testing site. In such a case, an entity may be able to send an alert or other indication to other entities such as card holders, card issuers, card associations, third party processors, etc. In addition, or alternatively, some entities such as an issuing bank may be able to deactivate a card after receiving such information.

At step 1060 flowchart 1000 ends.

Embodiments of the present disclosure have been described herein with reference to numerous specific details that can vary from implementation to implementation. Certain adaptations and modifications of the described embodiments can be made. Other embodiments can be apparent to those skilled in the art from consideration of the specification and practice of the embodiments disclosed herein. It is intended that the specification and examples be considered as exemplary only, with a true scope and spirit of the present disclosure being indicated by the following claims. It is also intended that the sequence of steps shown in figures are only for illustrative purposes and are not intended to be limited to any particular sequence of steps. As such, it is appreciated that these steps can be performed in a different order while implementing the exemplary methods or processes disclosed herein.

1. A system for identifying a merchant as a test site, the system comprising:
a memory device configured to store a set of instructions storing executable instructions that when executed by the processor causes the processor to perform steps of:
acquiring transaction data associated with one or more payment cards, the transaction data including a time of a transaction, a location of the transaction, and amount of the transaction, and a merchant identifier associated with the transaction;
identifying a pattern of transactions within the transaction data, the pattern of transactions associated with the one or more payment cards and the merchant identifier;
comparing the pattern of transactions to a database of abnormalities, the abnormalities associated with testing sites; and
determining that the merchant is a test site based on the comparing the pattern.

2. The system of claim 1, wherein the pattern of transactions includes transactions with an amount of zero.

3. The system of claim 1, wherein the pattern of transactions includes a plurality of transactions occurring over a period of time, and wherein amounts associated with the transactions increase over the period of time.

4. The system of claim 1, wherein the pattern of transactions occur over a period of time, and no transactions occur after a payment card is declined.

5. The system of claim 1, wherein the set of instructions further cause the one or more processors to:
determine a location associated with the pattern of transactions.

6. The system of claim 1, wherein the set of instructions further cause the one or more processors to:
flag the additional payment cards that are associated with the merchant as potentially being compromised.

7. The system of claim 1, wherein the set of instructions further cause the one or more processors to:
send a notification to one or more issuers of the determined additional payment cards that are associated with the merchant.

8. A method for determining payment card testing, the method comprising:
acquiring transaction data associated with one or more payment cards the transaction data including a time of a transaction, a location of the transaction, and amount of the transaction, and a merchant identifier associated with the transaction;
identifying a pattern of transactions within the transaction data, the pattern of transactions associated with the one or more payment cards and the merchant identifier;
comparing the pattern of transactions to a database of abnormalities, the abnormalities associated with testing sites; and
determining that the merchant is a test site based on the comparing the pattern.

9. The method of claim 8, wherein the pattern of transactions includes transactions with an amount of zero.

10. The method of claim 8, wherein the pattern of transactions includes a plurality of transactions occurring over a period of time, and wherein amounts associated with the transactions increase over the period of time.

11. The method of claim 8, wherein the pattern of transactions occur over a period of time, and no transactions occur after a payment card is declined.

12. The system of method of claim 8, wherein the method further comprises:
determining a location associated with the pattern of transactions.

13. The method of claim 8, wherein the method further comprises:
flagging the additional payment cards that are associated with the merchant as potentially being compromised.

14. The method of claim 8, wherein the method further comprises:
sending a notification to one or more issuers of the determined additional payment cards that are associated with the merchant.

15. A non-transitory computer-readable medium storing a set of instructions that are executable by one or more processors to cause the one or more processors to perform a method to determine payment card testing, the method comprising:
acquiring transaction data associated with one or more payment cards the transaction data including a time of a transaction, a location of the transaction, and amount of the transaction, and a merchant identifier associated with the transaction;
identifying a pattern of transactions within the transaction data, the pattern of transactions associated with the one or more payment cards and the merchant identifier;
comparing the pattern of transactions to a database of abnormalities, the abnormalities associated with testing sites; and
determining that the merchant is a test site based on the comparing the pattern.

16. The method of claim 15, wherein the pattern of transactions includes transactions with an amount of zero.

17. The non-transitory computer-readable medium of claim 15, wherein the pattern of transactions includes a plurality of transactions occurring over a period of time, and wherein amounts associated with the transactions increase over the period of time.

18. The non-transitory computer-readable medium of claim 15, wherein the pattern of transactions occur over a period of time, and no transactions occur after a payment card is declined.

19. The non-transitory computer-readable medium of claim 15, wherein the method further comprises:
determining a location associated with the pattern of transactions.

20. The non-transitory computer-readable medium of claim 15, wherein the method further comprises:
sending a notification to one or more issuers of the determined additional payment cards that are associated with the merchant.
